(19) United States
(12) Patent Application Publication
(10) Pub. No.: US 2025/0325003 A1
(43) Pub. Date: Oct. 23, 2025

(54) Preparation method of pre-gelatinized pea protein powder

(71) Applicant: Dahui International Food Co, Ltd

(72) Inventor: Feng Gu, Bangkok (TH)

(21) Appl. No.: 19/253,962

(22) Filed: Jun. 30, 2025

(51) Int. Cl. A23J 3/14

(52) U.S. Cl. CPC A23J 3/14

(57) ABSTRACT

A preparation method of pre-gelatinized pea protein powder includes steps of (A) mixing original pea protein powder material with deionized water, and obtaining serosity after stirring; (B) heating a surface temperature of a drum, sending the serosity obtained by step (A) to a surface of the drum with a pump, forming a film on the surface of the drum through the rotation of the drum, immediately gelatinizing, and obtaining a pea protein thin layer after quickly dehydrating and drying; (C) peeling the pea protein thin layer off with a scraper when a moisture of the pea protein thin layer obtained by step (B) decreases to 5%, pulverizing with a multi-functional pulverizer, and feeding a pulverized product into a circular vibrating screen by gas extraction; and (D) removing large particles of pea protein powder by the circular vibrating screen, so that the pre-gelatinized pea protein powder is obtained.

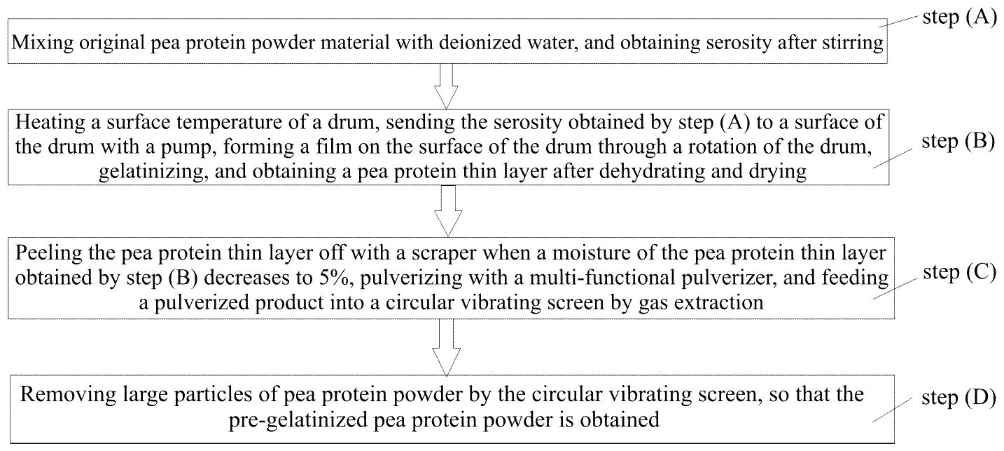

### BACKGROUND OF THE PRESENT INVENTION

### Field of Invention

The present invention relates to the field of deep processing of agricultural by-products and food industry technology, and more particularly to a preparation method of pre-gelatinized pea protein powder.

### Description of Related Arts

Pea protein powder is a high-quality protein extracted from peas. Compared with soybean protein and wheat protein, pea protein has the characteristics of low allergenicity, low calorie and high protein content, so it is highly favored in the field of high-protein nutritional supplements. However, pea protein has a beany bitter taste and a sense of sand, and is accepted by relatively few people, which limits its applications. At present, it is an important means to increase the value of pea protein by improving the functional characteristics of plant protein, such as the solubility of pea protein powder, and removing the beany taste. The commonly used methods include physical methods, biological enzymatic methods and chemical methods. However, food safety and environmental problems caused by chemical reactions and reagent residues have restricted the application of pea protein in food processing. Protease hydrolysis is able to improve the solubility of proteins, it will cause proteins to lose some properties of biological macromolecules (such as gelation), and at the same time, protease hydrolysis will also produce bitter peptides, which limits the application of hydrolysates. Moreover, some manufacturers choose to add flavorings and fragrances to mask the bitter taste of beans and use emulsifiers to improve the taste. This method has problems such as food safety risks and poor taste. The present invention provides a physical method to change the properties of pea protein, enabling it to dissolve in cold water and eliminating the original beany smell, thereby enhancing the convenience of eating.

### SUMMARY OF THE PRESENT INVENTION

An object of the present invention is to provide a preparation method of pre-gelatinized pea protein powder, so that the pre-gelatinized pea protein powder is able to be dissolved in cold water, and has the unique aroma of peas after removing the original beany smell, and thereby improving the convenience of eating and expanding the application scope thereof.

To solve the above technical problem, the present invention provides a technical solution as follows.

A preparation method of pre-gelatinized pea protein powder comprises steps of:
(A) mixing original pea protein powder material with deionized water, obtaining serosity with a concentration in a range of 30%-40% after stirring, and maintaining a temperature of the serosity at 30-40° C.;
(B) heating a surface temperature of a drum to 150-160° C. by introducing steam into the drum, sending the serosity obtained by step (A) to a surface of the drum with a pump, forming a film on the surface of the drum through the rotation of the drum, immediately gelatinizing, and obtaining a pea protein thin layer after quickly dehydrating and drying;
(C) peeling the pea protein thin layer off with a scraper when a moisture of the pea protein thin layer obtained by step (B) decreases to 5%, pulverizing with a multi-functional pulverizer, and feeding a pulverized product into a circular vibrating screen by gas extraction; and
(D) removing large particles of pea protein powder by the circular vibrating screen with a mesh number of 100, so that the pre-gelatinized pea protein powder is obtained.

The present invention has some beneficial effects as follows.
(1) The pre-gelatinized pea protein powder provided by the present invention solves the problems of beany smell and sandy taste existing in the current pea protein powder, and improves the taste and acceptance of the product.
(2) The present invention adopts a physical method to avoid food safety risks and environmental problems caused by chemical methods and protease hydrolysis methods.
(3) The pre-gelatinized pea protein powder provided by the present invention is soluble in water at normal temperature, which improves the convenience of eating and expands the application range.

### BRIEF DESCRIPTION OF THE DRAWINGS

The drawing is a flow chart of a preparation method of pre-gelatinized pea protein powder provided by the present invention.

### DETAILED DESCRIPTION OF THE PREFERRED EMBODIMENT

The present invention is further described in detail below with reference to the accompanying drawings and embodiments. It is understood that the specific embodiments described herein are merely illustrative of the invention and are not intended to limit the invention. The components of the embodiments of the present invention, which are generally described and illustrated in the figures herein, may be arranged and designed in various different configurations.

### First Embodiment

A preparation method of pre-gelatinized pea protein powder comprises steps of:
(A) mixing original pea protein powder material with deionized water, obtaining serosity with a concentration of 35% after stirring, and maintaining a temperature of the serosity at 35° C.;
(B) heating a surface temperature of a drum to 155° C. by introducing steam into the drum, sending the serosity to a surface of the drum with a pump, forming a film on the surface of the drum through the rotation of the drum, immediately gelatinizing, and obtaining a pea protein thin layer after quickly dehydrating and drying;
(C) peeling the pea protein thin layer off with a scraper when a moisture of the pea protein thin layer decreases to 5%, pulverizing with a multi-functional pulverizer, and feeding a pulverized product into a circular vibrating screen by gas extraction; and
(D) removing large particles of pea protein powder by the circular vibrating screen with a mesh number of 100, so that the pre-gelatinized pea protein powder is obtained.

The prepared pre-gelatinized pea protein powder has good solubility in normal temperature water, no beany smell, and a delicate taste, which meets the expected goals.

### Second Embodiment

A preparation method of pre-gelatinized pea protein powder comprises steps of:
(A) mixing original pea protein powder material with deionized water, obtaining serosity with a concentration of 40% after stirring, and maintaining a temperature of the serosity at 40° C.;
(B) heating a surface temperature of a drum to 160° C. by introducing steam into the drum, sending the serosity to a surface of the drum with a pump, forming a film on the surface of the drum through the rotation of the drum, immediately gelatinizing, and obtaining a pea protein thin layer after quickly dehydrating and drying;
(C) peeling the pea protein thin layer off with a scraper when a moisture of the pea protein thin layer decreases to 5%, pulverizing with a multi-functional pulverizer, and feeding a pulverized product into a circular vibrating screen by gas extraction; and
(D) removing large particles of pea protein powder by the circular vibrating screen with a mesh number of 100, so that the pre-gelatinized pea protein powder is obtained.

Also, the prepared pre-gelatinized pea protein powder has good solubility in normal temperature water, no beany smell, and a delicate taste, which meets the expected goals.

In step (A), the concentration of serosity is adjustable to be adapt to different production demands.

In step (B), gelatinizing is able to be achieved by other heating devices or methods, such as microwave heating, as long as the same gelatinization effect is achieved.

In step (C), different types and modifications of pulverizers are able to selected to meet different fineness requirements.

In step (D), different types and modifications of screens are able to selected to meet different fineness requirements.

One skilled in the art will understand that the embodiments of the present invention as shown in the drawings and described above are exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A preparation method of pre-gelatinized pea protein powder, comprising steps of:
(A) mixing original pea protein powder material with deionized water, and obtaining serosity after stirring;
(B) heating a surface temperature of a drum, sending the serosity obtained by step (A) to a surface of the drum with a pump, forming a film on the surface of the drum through a rotation of the drum, gelatinizing, and obtaining a pea protein thin layer after dehydrating and drying;
(C) peeling the pea protein thin layer off with a scraper when a moisture of the pea protein thin layer obtained by step (B) decreases to 5%, pulverizing with a multi-functional pulverizer, and feeding a pulverized product into a circular vibrating screen by gas extraction; and
(D) removing large particles of pea protein powder by the circular vibrating screen, so that the pre-gelatinized pea protein powder is obtained.

2. The preparation method according to claim 1, wherein in step (A), a concentration of the serosity is in a range of 30%-40%, and a temperature of the serosity is maintained at 30-40° C.

3. The preparation method according to claim 1, wherein in step (B), the surface temperature of the drum is heated to 150-160° C. by introducing steam into the drum.

4. The preparation method according to claim 2, wherein in step (B), the surface temperature of the drum is heated to 150-160° C. by introducing steam into the drum.

5. The preparation method according to claim 1, wherein in step (D), the circular vibrating screen has a mesh number of 100.

6. The preparation method according to claim 2, wherein in step (D), the circular vibrating screen has a mesh number of 100.

7. The preparation method according to claim 3, wherein in step (D), the circular vibrating screen has a mesh number of 100.

8. The preparation method according to claim 4, wherein in step (D), the circular vibrating screen has a mesh number of 100.
